(19) United States
(12) Patent Application Publication
(10) Pub. No.: US 2012/0085040 A1
(43) Pub. Date: Apr. 12, 2012

(54) LOW PROFILE ELECTRICAL CONNECTION SYSTEM

(75) Inventor: RONALD KETWITZ, JR., RUTHERFORDTON, NC (US)

(73) Assignee: DELPHI TECHNOLOGIES, INC., TROY, MI (US)

(21) Appl. No.: 13/251,330

(22) Filed: Oct. 3, 2011

Related U.S. Application Data
(60) Provisional application No. 61/390,771, filed on Oct. 7, 2010.

(51) Int. Cl. E04D 13/18; H01R 24/00; H01R 13/62; H01R 43/20

(52) U.S. Cl. 52/173.3; 29/876; 29/883; 439/660; 439/345

(57) ABSTRACT

An electrical connection system is presented that is especially suited for use with a solar shingle application disposed on a rooftop of a building structure. The electrical connection system, when underlying roof shingles disposed on the rooftop, has a low profile that prevents an undesired buckled visual appearance from occurring to the roof shingles over a service life of the roof shingles. The electrical connection system has a thickness that is about a diameter thickness of at least one wire conductor that attaches with at least one connector body of the electrical connection system. The electrical connection system further includes at least one latch mechanism, that when sufficiently engaged against by a tool, allows a plug connector body to unmate from a socket connector body or a shunt socket connector body. A method to construct the at least one connector of the electrical connection system is also presented.

### RELATED DOCUMENTS

This application claims priority to provisional application U.S. Ser. No. 61/390,771 filed on 7 Oct. 2010.

### TECHNICAL FIELD

This invention relates to an electrical connection system, more particularly, a low profile electrical connection system employed in a solar shingle electrical application is configured to underlie roof shingles without causing buckling to the roof shingles and further includes a latch mechanism, that when sufficiently engaged with by a tool, allows unmating of mated connector bodies in the electrical connection system.

### BACKGROUND OF INVENTION

It is known to electrically connect one solar roof shingle to another solar roof shingle using a connection system during construction of the solar shingles on a rooftop.

Current connection systems used for solar roof shingles have a thickness that may make connectors in the connection system difficult to hide under the solar roof shingles during installation. The thickness of current solar connection systems may have a sufficient thickness that causes noticeable visual buckling of a solar shingle and may prevent the solar shingle to lie flat on the decking, or external surface of a rooftop during solar shingle installation. Buckling of the solar shingle may cause the solar shingle to undesirably crack or break which may result in decreased useful life of the solar shingle. Moreover, an undesired crack in the shingle may further undesirably render the shingle electrically inoperative. With increased interest from consumers in renewable energy technology, solar shingles will continue to remain a viable energy choice. Homeowners may also desire the look of aesthetically-pleasing purplish-blue solar shingles in contrast to solar panels which may be undesirably less aesthetic, have more mass than a typical solar shingle, and require a larger footprint when disposed on the rooftop. As such, it will remain desirable to maintain or increase the electrical signal transmission robustness provided by solar roof shingles. To further enhance the electrical signal transmission, it is desired that the connection system be environmentally sealed for protection from environmental elements experienced on the rooftop. It is further desirable to accomplish these tasks while enhancing the cosmetic appearance of the roof shingles on the rooftop over the service life of the roof shingles.

Thus, a low profile electrical connection system is needed to overcome the abovementioned shortcomings that reliably transmits electrical signals generated by the solar roof shingles, prevents at least liquid fluid intrusion in to the electrical connection system, and preserves a high quality, visually cosmetic appearance of the roof shingles on the rooftop over a service life of the roof shingles.

### SUMMARY OF THE INVENTION

An electrical connection system includes a mating axis and at least one socket connector body configured to receive at least a portion of a plug connector body along the mating axis. The plug connector body includes a generally axial planar first wall and a generally axial planar second wall opposingly spaced from the planar first wall by about a diameter thickness of at least one wire cable. The at least one wire cable is electrically connected to at least one electrical contact forming at least one wire assembly disposed intermediate the first and the second wall. The first wall has a planar exterior surface and the second wall has a planar exterior surface. A first plane is defined along the planar exterior surface of the first wall and a second plane is defined along the planar exterior surface of the second wall such that said first plane has a parallel, spaced relationship with said second plane. The plug connector body further includes at least one latch mechanism. The at least one latch mechanism is configured to secure the plug connector body to the at least one socket connector body so that the plug and the socket connector body are fully mated together. The plug connector body is unmatable from the socket connector body when the latch mechanism is sufficiently engaged thereat by a tool. When the plug connector body is fully mated to the socket connector body the electrical connection system is generally disposed intermediate the first and the second plane.

In another embodiment of the invention, the plug connector includes a plurality of bosses where each boss has a different width that allows keyed mating of the plug connector and the socket connector in a single way.

In a yet a further embodiment of the invention, a method to construct at least one connector for an electrical connection system is presented. One step in the method is plasma etching at least a section of insulation outer covering that surrounds an inner core of at least one wire cable. A portion of the insulation outer covering proximate an end of the wire cable is removed to expose a portion of the inner core to form a lead of the wire cable. The section of insulation outer covering is disposed adjacent the lead. Another step in the method is attaching the lead to at least one electrical contact to form at least one wire assembly. A further step in the method is disposing the at least one wire assembly in a mold. Another step in the method is injection molding a connector body to surroundingly engage the wire assembly including at least a portion of the insulation outer covering adjacent the lead to form the at least one connector.

Further features, uses and advantages of the invention will appear more clearly on a reading of the following detailed description of the preferred embodiment of the invention, which is given by way of non-limiting example only and with reference to the accompanying drawings.

### BRIEF DESCRIPTION OF THE DRAWINGS

This invention will be further described with reference to the accompanying drawings in which:

FIG. 1 shows an electrical connection system employed in a solar shingle application on a rooftop of a building structure, in accordance with the invention;

FIG. 2A shows a plug and a socket connector of the electrical connection system of FIG. 1 mated together;

FIG. 2B shows the plug and the socket connector of FIG. 2A mated together and a tool engaging the latch mechanisms;

FIG. 2C shows the plug and the socket connector of FIG. 2B being unmated;

FIG. 3 shows a horizontal cross section view of the mated plug and the socket connector of FIG. 2A, along the lines 3-3;

FIG. 4 shows a top view of the mated plug and socket connector of FIG. 2A;

FIG. 5 shows a vertical cross section view of the mated plug and socket connector of FIG. 4 through the lines 5-5, and details thereof;

FIG. 6 shows a magnified view of an irregularly sized opening defined in the plug connector of FIG. 4, and details thereof; and

FIG. 7 shows a method to construct a connector associated with the electrical connection system of FIG. 1.

### DETAILED DESCRIPTION

Solar roof shingles may resemble conventional asphalt roof shingles. As such, in some roofing applications, solar shingles may be intermixed with conventional asphalt shingles. One difference between a solar roof shingle and a conventional asphalt shingle is that solar roof shingles contain an electrical photovoltaic device. When installed on a rooftop of a building structure, such as an office building or a home, these installed solar roof shingles capture rays of sunlight that strike the solar shingles. The photovoltaic device converts the sunlight to energy that may be electrically stored. The electrically stored energy may be used to power electrical devices in the home or office building that contains the installed solar shingle rooftop. Alternately, the stored energy may be transferred back into a local power grid of an electric power company for use by electrical devices in electrical communication with the local power grid.

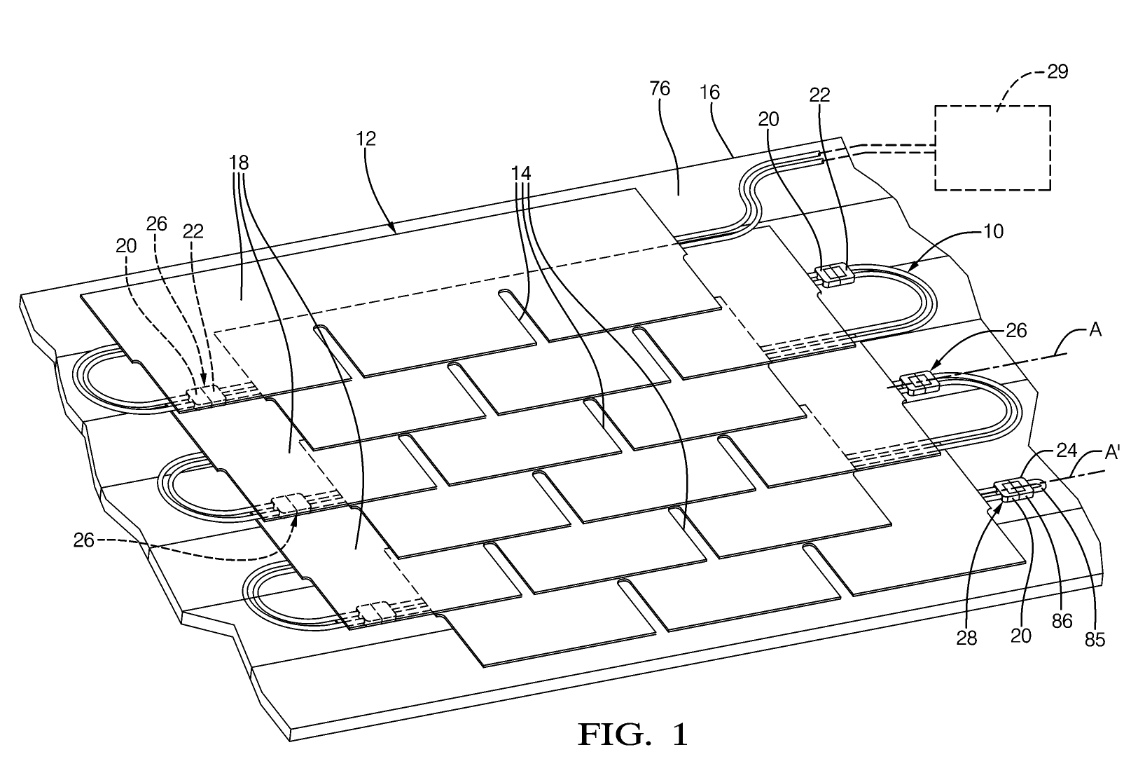

In accordance with the invention, referring to FIG. 1, a low profile electrical connection system 10 is employed among an array of shingles 12, some of which are solar shingles 14, disposed on a at least a portion of a rooftop 16 of a building structure (not shown). The building structure may be a home or an office building. As shown in FIG. 1, shingle array 12 also includes asphalt shingles 18. Alternately, the rooftop may contain any number of solar shingles or be intermixed with other shingle types or solar panels. Low profile electrical connection system 10 effectively electrically connects solar shingles 14 together to transfer electrical energy to another electrical device produced by the solar shingles.

Electrical connection system 10 includes three types of connectors: a plug connector 20, a socket connector 22, and a shunt socket connector 24. As best illustrated in FIG. 1, connectors 20, 22, 24 underlie asphalt shingles 18 on rooftop 16. Alternately, the plug, socket, and shunt socket connectors may underlie solar shingles on the rooftop. Still yet alternately, the plug, socket, or shunt socket connectors may be positioned on the rooftop so as to not underlie any of the roof shingles. Socket connector 22 receives the mating plug connector 20 along mating axis A. A primary plug and socket connector pair 26 are formed when plug connector 20 and socket connector 24 are mated together along mating axis A. Shunt socket connector 24 receives plug connector 20 along mating axis A′. A secondary plug and shunt socket connector pair 28 are formed when plug connector 20 and shunt socket connector 24 are mated together along mating axis A′. Shunt socket connector 24 is disposed at a downstream solar shingle in the electrical circuit and assists to electrically close, or complete the electrical circuit such that solar shingles 14 on rooftop 16 are electrically connected together. Shunt socket connector 24 is connected to a terminating plug connector in the electrical circuit. As illustrated in FIG. 1, this terminating plug connector is the last, or sixth plug connector remotely disposed from energy storage device 29. Energy storage device 29 stores the electrical energy generated by solar shingles 14 and may supply this stored energy to other electrical devices in the building structure and/or the local power grid. In one embodiment, the energy storage device may be disposed on the rooftop with the solar shingles. In another embodiment, the energy storage device may be disposed remotely from the rooftop. In yet other embodiments, instead of being electrically connected to the energy storage device, the electrical connection system may be in electrical communication with an inverter electrical device, or multiple banks of solar shingles, or the local energy power grid as determined by the application of use and the artesian in the solar shingle and wiring and connector arts. Because there is generally only a single secondary connector pair to electrically close an electrical circuit, many solar shingle electrical circuits have a greater number of primary connector pairs than secondary connector pairs. Alternately, a special end shingle may be constructed in contrast to using the shunt socket connector, but this adds undesired increased cost to install the solar shingle roof system. Piezoelectric devices (not shown) associated with the solar shingles may be electrically attached to the wire cables that communicate with respective primary and secondary electrical connector pairs 26, 28 to electrically connect the solar shingles with electrical connection system 10. In an alternate embodiment, a large rooftop may have a solar shingle arrangement where the a low profile connection system includes a plurality of plug connectors, a plurality of socket connectors, and a plurality of shunt socket connectors to electrically connect the solar shingle arrangement together. Still yet alternately, a plurality of low profile electrical connection systems may be employed in a plurality of solar shingle electrical circuits on the same rooftop depending on the desired electrical configuration for a solar shingle arrangement. Consideration of specific electrical connection system configurations used with various solar shingle arrangements are left for the artesian in the solar shingle and/or wiring and connector arts.

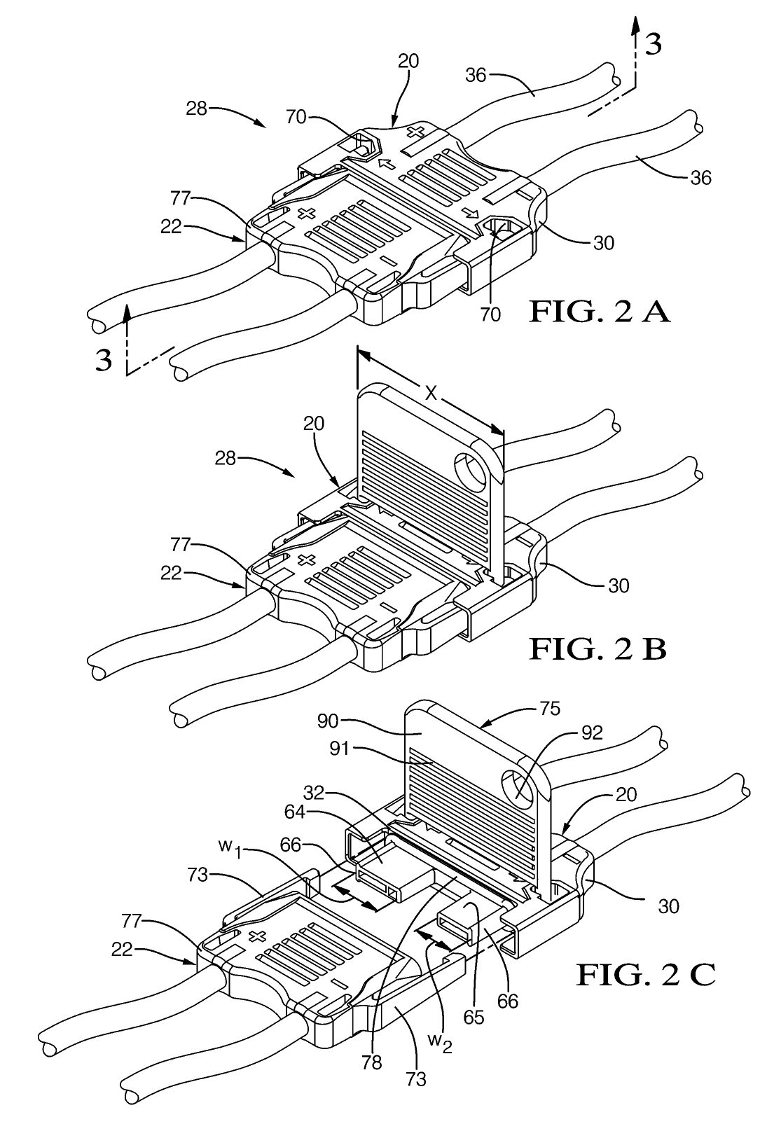

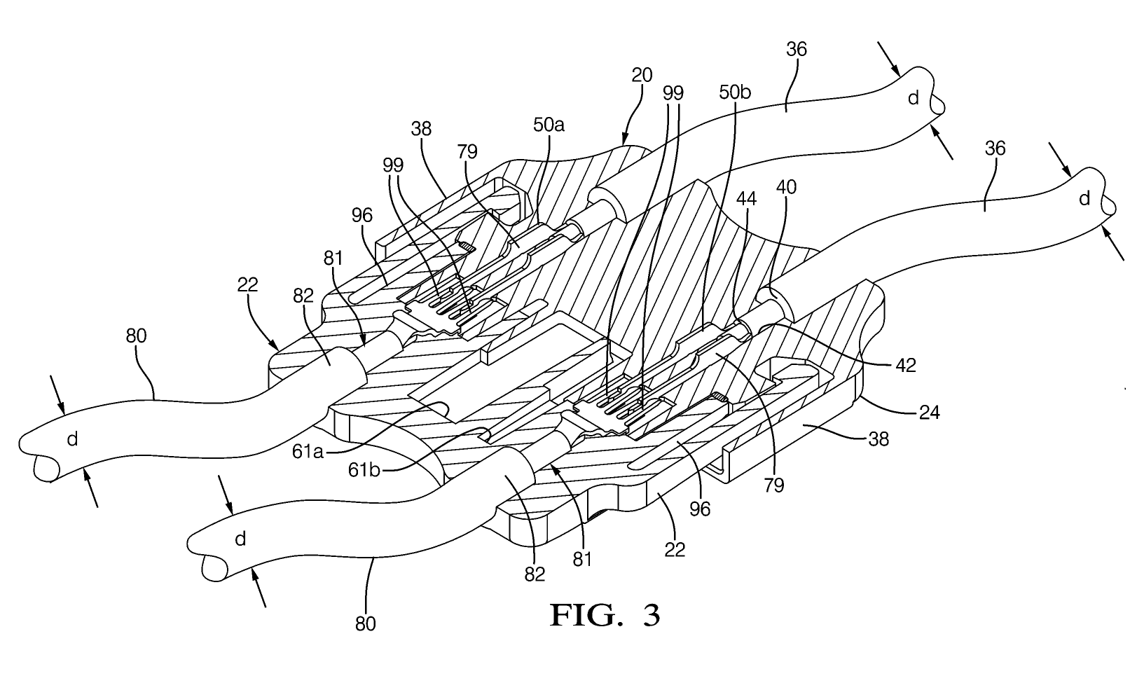

Referring to FIGS. 2-6, plug connector 20 will be described in greater detail. Plug connector 20 includes a plug connector body 30. Plug connector body 30 is constructed of a dielectric material. Preferably, plug connector body 30 is formed of a UL Fl thermoplastic material. Alternately, the plug connector body may be formed of any thermoplastic material that is acceptable for use in a solar shingle application. For the solar shingle application, the material used for the plug connector body should be robust enough to ensure UV, flame, and other voltage requirements are met that are typically encountered in the solar shingle application. Still yet alternately, other thermoplastic materials for the plug connector body may be chosen that are adequate for electrical applications that are not solar shingle applications. Plug connector body 30 includes a generally axial planar first wall 32 and a generally axial planar second wall 34 opposingly spaced from planar first wall 32 by about a respective diameter d thickness of two wire conductors, or cables 36. Sidewalls 38 join first wall 32 and second wall 34 together. Wire cables 36 have a dielectric insulation outer covering 40 that surrounds an electrically-conductive inner core 42. A portion 63 of insulation outer covering 40 proximate an end 44 of each wire cable 36 is removed, such as by wire stripping, to expose a portion of inner core 42 that is a lead 46 of cable 36. Lead 46 is received by a receiving portion 48 of a terminal, or an electrical contact 50 of plug connector 20 and attached to electrical contact 50, such as by crimping, as is known in the wiring and connector arts. After attachment, wire cable 36 and electrical contact 50 form a plug wiring assembly 52. Electrical contacts 50a, 50b each include a bifurcated male blade, or tine contact. Contacts 50a, 50b are preferably formed of an electrically conductive metal material, such as brass or tin. Inner core 42 is formed of a metal material such as copper or copper alloy, or aluminum. Insulation outer covering 40 may be formed of a dielectric, thermoplastic material. Preferably, insulation outer covering 40 has similar material chemical properties as those of the material that forms plug connector body 30. When connectors 20, 22 are mated, wire assemblies 52 are disposed in a single row perpendicular to mating axis A and axially disposed in plug connector body 30 intermediate first and second wall 32, 34. Wire assemblies 52 respectively engage an inner surface 57 of first wall and an inner surface 59 of second wall 32, 34. Referring to FIG. 5, first wall 32 has a generally planar exterior surface 54 and second wall 34 has a generally planar exterior surface 56. A first plane 58 is defined along exterior surface 54 of first wall 32 and a second plane 60 is defined along exterior surface 56 of second wall 34. First plane 58 is has a parallel relationship with second plane 60. When plug connector 20 is mated to socket connector 22, socket connector 22 is generally disposed intermediate first plane 58 and second plane 60. Diameter thickness d of the wire cable 36, and hence the overall thickness t of the plug connector 20 is related to an electrical current-carrying capacity of plug wire assemblies 52 that may be required for a specific solar shingle electrical application. Thickness t is generally greater than thickness d by the respective thickness of both first wall 32 and second wall 34. In some embodiments, a solar shingle electrical application may require an electrical current capacity through each wire assembly having an electrical range from zero (0) amps direct current (DC) to thirteen (13) amps DC. The thicknesses of the respective walls 32, 34 are generally less than diameter thickness d when the electrical connection system is required to electrically transmit up to thirteen (13) amps DC. Two hollow cavities 61a, 61b are formed in plug connector body 30 of plug connector 20. Hollow cavities 61a, 61b assist to aid in the manufacturability of the plug connector while also reducing material costs of plug connector body 30. The hollow cavities helps to mitigate the effects of shrinkage of the plug connector body after the plug connector body is injection molded and may also help for easy release of the plug connector body from the mold dependent on the mold tool design used. Alternately, the hollow cavities may be cored out after the plug connector body is injection molded.

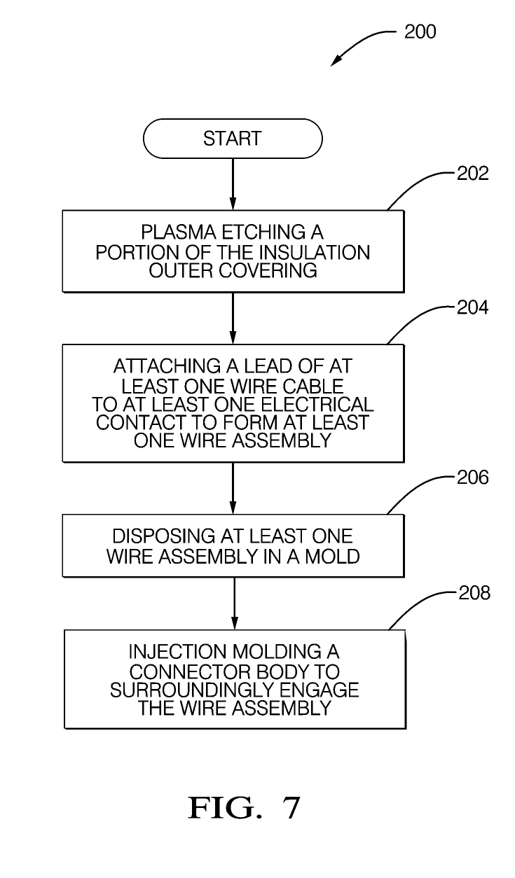

Referring to FIG. 7, plug connector body 30 is constructed by method 200. Step 202 of method 200 is plasma etching at least a section of insulation outer covering 40 that surrounds inner core 42 of at least one wire cable 36. In one embodiment, the wire cable is plasma etched when the wire cable is constructed before being rolled up on a take-up spool. In another embodiment, the section of insulation outer covering adjacent the lead is plasma etched. Another step 204 in method 200 is attaching lead 46 of wire cable 36 to at least one electrical contact 50 to form at least one plug wire assembly 52. A further step 206 in method 200 is disposing the at least one plug wire assembly 52 in a mold (not shown). Another step 208 in method 200 is injection molding plug connector body 30 so that plug connector body 30 overmolds and surroundingly engages plug wire assemblies 52 such that plug connector body 30 surroundingly sealingly engages against at least portion 63 of insulation outer covering 40 adjacent lead 46. Alternately, the wire cable may be plasma etched after the wire assembly of the plug connector is constructed.

Plasma etching at least the external surface of the insulation outer covering excites the molecular structure of insulation outer covering of the wire cables using an applied electric field so that the insulation outer covering adheringly engages to respective connector body when the connector body is injection molded. Additionally, as the insulation outer covering is plasma etched, undesired impurities and contaminants, such has human skin oils, are broken up that further assist to ensure an optimal seal between the insulation outer covering and the connector body. The plasma etching allows chemical bonding of the connector body and the insulation outer covering to achieve a sealed connector body. Preferably, the connector body and the outer insulation covering material are formed of materials having similar chemical properties that allow an effective, sufficient environmental seal between the connector body and the outer insulation covering. In solar shingle applications, preferably the insulation outer covering is formed of a cross-linked polyethylene XLPE material and the connector body is formed of a polyamide PA66 material. Preferably, the insulation outer covering is plasma etched just prior to molding of the connector body in a manufacturing assembly line to ensure an optimal seal between the insulation outer covering and the connector body. In one embodiment, an atmospheric gas is used and in another embodiment a helium gas is used. Any gas may be used that allows for an effective environmental seal of the connector body and the insulation outer covering to be attained. Socket connector body 77 and shunt socket connector body 86 are constructed similar to that of plug connector body 30 to form respective connectors 22, 24 using method 200.

A first plug boss 64 is in communication with first electrical contact 50a of plug connector 20 and a second plug boss 65 is in communication with second electrical contact 50b of plug connector 20. Thus, bosses 64, 65 extend from plug connector 20, and electrical contacts 50a, 50b extend through plug body 30 and in to bosses 64, 65. First plug boss 64 has a first width w₁ and second plug boss 65 has a second width w₂. First width w₁ is greater than second width w₂ so that the different widths of plug connector 20 allow a keyed insertion connection of bosses 65, 65 received by socket connector 22 in a single way. This feature prevents undesired mismating of the connection system. Alternately, the second width of the second boss may be greater than the first width of the first boss. First and second plug boss 64, 65 each have a laterally outbound alignment feature, or T-shaped protuberance 66 extending from a respective external surface of bosses 64, 65 so that socket connector body 77 receives plug connector body 30 only along mating axis A. T-shaped protuberances 66 are disposed along an axial length of the respective bosses 64, 65, as is best illustrated in FIG. 2C. T-shaped protuberance 66 assists to prevent off-axis connection of connectors 20, 22 that may otherwise cause possible irreparable damage to respective plug and socket connector 20, 22, and/or plug and shunt socket connector 20, 24 and associated wiring assemblies 52, 81 contained therein. A damaged connector or wire assembly needs replaced which increases services costs of the electrical connection system.

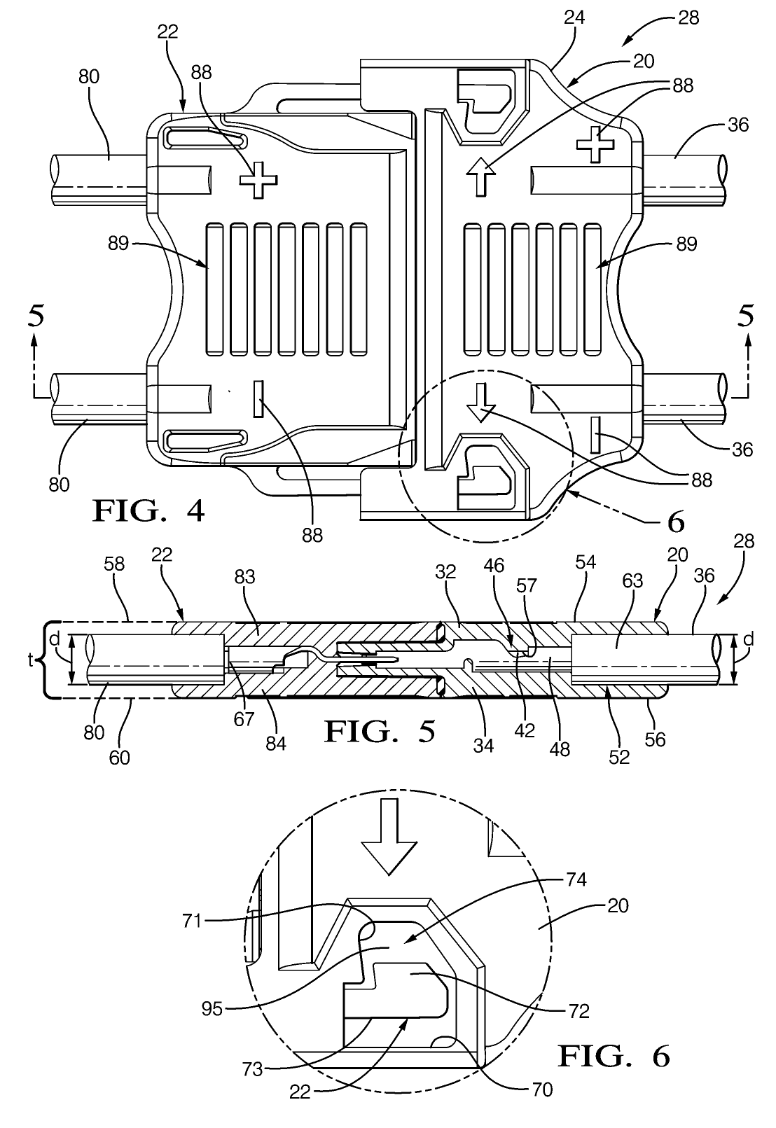

Referring to FIGS. 4 and 6, two laterally spaced, irregularly shaped openings 70 are defined in at least first wall 32 and second wall 34 of plug connector 20. A flattened portion or shoulder 71 of each opening 70 receives a nib 72 of a flexible extension arm 73 of socket connector 22. Flexible arm 73 extends outwardly away from socket connector 22 so that nib 72 engages shoulder 71 when plug and socket connector 20, 22 are mated together. When nib 72 engages shoulder 71, plug connector 20 is secured to socket connector 24 such that plug and socket connector 20, 22 are fully mated. Thus, nib 72 and shoulder 71 combine to form latch mechanism 74. When latch mechanism 74 fully secures primary connector pair 26 together, latch mechanism 74 is disposed in a latched state. Plug connector 20 is unmatable from socket connector 22 when latch mechanism 74 is engaged thereat by a tool 75 perpendicular to the mating axes A, A′.

When tool 75 is inserted in a direction perpendicular to mating axis A, A′, an external surface 76 of rooftop 16 provides a hardened backdrop for primary and secondary connection pairs 26, 28 that allows for easier insertion of tool 75 to engage latch mechanism 74. When both latch mechanisms 74 are sufficiently engaged by tool 75 at respective gaps 95, a human roof installer merely unmates the respective primary and secondary connection pair 26, 28 along respective axis A, A′ adjacent roof external surface 76 without having to raise, or lift the primary and secondary connection pair 26, 28 away from external surface 76. As best illustrated in FIG. 6, gap 95 is defined in plug connector 20 disposed in at least one opening 70 when latch mechanism 74 is in the latched state. Gap 95 is defined intermediate nib 72 and an opposing interior surface of at least one opening 70. Perpendicular insertion of tool 75 may lessen the probability for the roof installer or service technician to damage connectors 20, 22, 24 in connector pairs 26, 28 during installation or when servicing connection pairs 26, 28. It has been observed that dust and water spray tests have shown connection pairs 26, 28 to have an ingress protection (IP) 65 rating. The IP 65 rating relates to a sealing rating system used with sealed enclosures, one of which is electrical connection system 10.

Referring to FIG. 2B, when latch mechanism 70 in each opening 62 is engaged by tool 72 such that tool 72 sufficiently urges flexible arms 68 to move in a direction outbound from plug connector 20 away from abutment with shoulders 64, plug connector 20 is unmatable from socket connector 22. Latch mechanism 70 is in an unlatched state when plug connector 20 is unmatable from socket connector 22. Should tool 75 be inserted in openings 70 against latch mechanisms 74 from an off-axis direction, the flex arms 73 may undesirably not clear shoulders 71, and hence, plug connector 20 may undesirably not unmate from socket connector 22.

Advantageously, tool 75 is insertable in openings 70 adjacent first wall 32 or inserted in opening 70 adjacent second wall 34. Thus, electrical connector system 10 does not need a specific orientation with respect to first wall 32 or second wall 34 facing away from external surface 76 of rooftop 16 to ensure easy installation or serviceability. When connectors 20, 22 or 22, 24 are secured with latch mechanism 74, this ensures that connectors in the electrical connection system are not inadvertently unconnected, such as may occur if vibrations from the roof installer or a homeowner walking on the rooftop or directly stepping on the connectors. Thus, a direct intention is needed to unmate connectors 20, 22 and 22, 24 in electrical connection system 10. Latch mechanism 70, when accessed by tool 75, is used to implement this intention. The latch mechanism of secondary pair 28 is similarly latched and unlatched similar to primary pair 26 previously discussed herein.

Referring to FIG. 1, when roof shingles 12 are installed on rooftop 16, roof shingles 12 have a planar parallel relationship with external surface 76 of rooftop 16. With the low profile composition of the electrical connection system 10, plurality of plug connectors 20 and the plurality of socket connectors 22 are configured to underlie roof shingles 12 so that the planar parallel relationship with exterior surface 76 of rooftop 16 is generally maintained. As shown in FIG. 1, some of the connectors 20, 22 are shown to underlie asphalt shingles in the solar shingle array 12.

Socket connector 22 is constructed in similar fashion to that of plug connector 20 as previously discussed. However, socket connector 22 is different from plug connector 20 in that socket connector 22 includes corresponding laterally spaced electrical bifurcated forked contacts 79 that each attach to leads 67 of socket wire cables 80 to form a socket wire assembly 81. Socket wire cables 80 have the same diameter thickness d as plug wire cables 36 of plug connector 20 and are also similarly plasma etched according to method 200. Socket connector body 77 surrounds socket wire assembly 81 in a similar fashion to that of plug connector body 30 including surrounding and engaging insulation outer covering 82 of socket wire cables 80. Socket connector body 77, similar to plug connector body 30, includes a first wall 83, second wall 84, and sidewalls 96. Socket wire assemblies 81 are engaged with first and second wall 83, 84 of socket connector body 77 similar to plug connector 20. When plug and socket connector body 30, 77 are mated together and latch mechanism 74 is disposed in the latched state, first wall 32 of the plug connector body 30 communicates with first wall 83 of socket connector body 77 and second wall 34 of plug connector body 30 communicates with second wall 84 of socket connector body 77. Sidewalls 38 of plug connector 20 also communicate with sidewalls 96 of socket connector body 77. Each forked contact 99 on each of the two electrical contacts 81 is spaced apart perpendicular to the mating axis at least when plug and socket connector 20, 22 are mated. This packaging arrangement of forked contacts 99 of electrical terminals, or contacts 81 of socket connector 22 advantageously aids in the low profile nature of the electrical connection system 10 so that electrical connection system 10 is disposed between first plane 58 and second plane 60. Each forked contact 99 is dispose along a plane with the other forked contacts 99 on electrical contacts 81 perpendicular to axis A or axis A′ at least connection system 10 is fully mated. These forked contacts being disposed along the same plane complement the low profile of electrical connection system 10. The forked contacts receive the corresponding bifurcated male blades of plug connector 20 when plug and socket connector 20, 22 are mated or when plug and shunt socket connectors 20, 24 are mated.

Shunt socket connector 24 is constructed in similar fashion to socket connector 22 as previously discussed. Socket connector body 77 and shunt connector body 86 are identical and shunt connector 22 utilizes the same male electrical contacts 81 as socket connector 22. In contrast with socket connector 22, shunt socket connector 24 includes a wire conductor 85 that electrically connects, or electrically shunts each electrical contact 81 in shunt socket connector 24 together. Wire conductor 85 has the same diameter thickness d as respective wire cables 36, 80 associated with plug and socket connectors 20, 22. A shunt connector body 86 of shunt socket connector 24 is constructed from the same material as that of plug connector body 30 previously described herein. When the plug and shunt socket connector 22, 24 are mated, secondary electrical connector pair 28 has a thickness t which is identical to the thickness of primary connector pair 26.

Wire polarity symbols 88 are disposed on the first and/or the second sides of connectors 20, 22, 24. A plurality of grooves 89 are defined in the first and/or second sides of connectors 20, 22, 24. Plurality of grooves 89 are also referred to as ‘thumb bumps.’ Thumb bumps 89 communicate with the thumbs on a human hand of the roof installer to assist in mating and unmating connectors 20, 22 or connectors 20, 24 in electrical connection system 10. Symbols 88 and grooves 89 are constructed when connectors 20, 22, 24 are molded. Symbols 88 are raised symbols on the external surfaces of the connectors and are useful to roof installers to ensure correct electrical wiring polarity when electrically connecting up solar shingles 14 on rooftop 16. Thumb bumps 89 advantageously provide a textured, tactile gripping surface for roof installers to more easily mate and unmate connectors 20, 22, 24 in respective primary and secondary connector pairs 26, 28.

Two sealing features combine to make low profile electrical connection system 10 an environmentally sealed electrical connection system from at least liquid fluid intrusion. First, as best illustrated in FIG. 2C, a sealing ring 78 is disposed to surround first and second boss 64, 65 and is held in place with a friction fit against bosses 64, 65. When plug and socket connector 20, 22 are fully mated together, sealing ring 78 is disposed intermediate ends of respective plug and the socket connector bodies 30, 77 such that connector bodies 30, 77 sealingly engage against ring 78. Seal ring 78 seals a first potential leak path in respective primary or secondary connector pairs 26, 28 where the connectors matingly interface. Secondly, each of the connector bodies 30, 77, 86 overmold each of the respective wiring assemblies to sealingly engage against outer insulation covering of the respective wire cables 36, 80, 85 attached to these connectors 20, 22, 24. When the connector body sealing engages against the outer insulation covering of the respective wire cables, a second potential leak path in primary or secondary connector pairs 26, 28 when the connectors matingly interface. Thus, when mated, electrical connection system 10 is sealed from at least outward environmental liquid fluids from inbound penetration in to the first and the second potential leak path of the primary and the secondary connector pairs 26, 28. While not intended to be a connection system operable with sustained immersion in liquid environments over long time periods, it has also been observed that respective connector pairs 26, 28 respectively have no noticeable fluid leakage therein when submerged under about fifteen (15) centimeters of water for a time duration of sixty (60) seconds. This submersion level creates a pressure of about 0.2 pounds per square inch (psi).

Referring to FIGS. 2B and 2C, tool 75 has a pair of prongs 87 having a parallel, spaced relationship by a distance x which is a lateral distance perpendicular to axis A or A′ between openings 70 so that tool 75 may properly engage gap 95 adjacent latch mechanism 74. Prongs 87 may be made from any solid material, preferably a metal material. A portion of prongs 87 are overmolded with a tool body 90. Tool body 90 may be formed with any type of plastic material to provide structure and rigidity for prongs 87 that allow the roof installer or service technician to manipulate tool 75 to engage latch mechanism 74. Tool 75 advantageously allows engagement with both latch mechanisms 74 at the same time so that plug and socket connector 20, 22 or plug and shunt socket connector 20, 24 are unmatable in a single motion. Alternately, a readily available roofing nail or a small screwdriver having an end small enough to enter the opening and the gap in the plug connector may be used. However, when a roofing nail or small screwdriver used only one-half of the primary and/or secondary connector pair is unlatchable at a time which increases the amount of time needed to unlatch the electrical connection system. When only one-half of the electrical connection system is unlatched, the connectors are not yet unmateable. Each of the two latching mechanisms 74 need to be unlatched so plug and socket connector are unmatable, as best illustrated in FIGS. 2A and 2B. When using the roof nail or the small screwdriver, additional adjustment of the connectors by using hands of the roof installer or service technician may also be needed to ensure the plug and socket or the plug and shunt socket connector are completely unmatable. This undesirably adds even more time to unmate the connectors in the electrical connection system. Tool body 90 also includes thumb bumps 91 defined in external surfaces of tool body 90. An aperture 92 defined in tool body 90 serves to allow tool 75 to be attached to a key ring or similar device to better ensure that tool 75 is not easily lost by the roof installer.

If at least one primary connector pair 26 is not fully mated, electrical connection system 10 is not in use. If at least one secondary connector pair 28 is not fully mated, electrical connection system 10 is not in use. When the primary and/or the secondary connector pairs are not fully mated, faulty electrical conductivity may result in the electrical circuit where electrical connection system 10 is employed.

If primary connector pairs 26 or secondary connector pair 28 are fully mated and installed in a solar shingle electrical circuit, but the entire electrical circuit that employs electrical connection system 10 is not fully employed, electrical operation may occur through the installed primary and/or secondary electrical connections and if the roof installer employs other devices or connections to complete the electrical circuit, for example, to test a portion of the solar shingle electrical system. With this scenario, electrical connection system 10 would be partially in use.

Referring to FIG. 1, when the primary and secondary connector pairs 26, 28 are electrically connected and fully latched together with the respective latch mechanisms so that there is an operative electrical circuit, electrical connection system 10 is in use.

Alternately, the electrical connection system may be employed for any electrical application where a low profile electrical connection system is needed.

Still yet alternately, the solar shingles may be installed on any type of structure where rays of sunlight may be captured by the solar shingles and converted to energy to power electrical devices.

In another alternate embodiment, electrical contacts in the electrical connection system may have differing length forked elements and male blades to ensure a staggered mating arrangement. The staggered mating arrangement ensures the needed mating pressure to mate the connectors in the respective primary and the secondary connector pairs is advantageously decreased as not all the forked element/male blade connections are connected at the same time when connectors in the primary and/or the secondary connector pairs are mated.

Alternately, the hollow cavities may be in one of the connectors in the connector system and not in the other connector in the electrical connection system. In another alternate embodiment, none of the connectors in the electrical connection system have hollow cavities.

Thus, a low profile electrical connection system is presented that reliably transmits electrical signals generated by the solar roof shingles. A sealing ring intermediate ends of the plug and socket or shunt socket connectors prevents at least liquid fluid intrusion from entering a possible first leak path in the electrical connection system. A connector body overmolds the wire assemblies that includes a portion of the outer insulation covering of the associated wire conductors that is plasma etched to prevent at least liquid fluid flow from entering a potential second leak path through the wire cables and in to the electrical connection system. The thickness of the primary and secondary connector pairs ensures that if these pairs are hidden to underlie a solar, asphalt or other type of shingle, that the respective shingle maintains a generally parallel relationship with an external surface of the rooftop to preserve a high quality, visually cosmetic appearance of the rooftop over the lifetime of the roof shingles. A convenient, simple latch mechanism consists of a combination of a shoulder on the plug connector and an engaging nib disposed on a flexible extension arm of the socket or shunt socket connector to ensure that intention is required to unmate the connectors in the primary and/or secondary connector pair. A latch mechanism is intentionally unlatchable by using a tool applied against the latch mechanism that allows the unmating of the connectors in the electrical connection system. Preferably, a tool simultaneously engages the pair of latch mechanisms of the primary and/or secondary pair to allow the connectors in the primary or secondary connector pair to be unmateable in a single motion. A first and a second boss of the plug connector have differing widths. These differing widths are disposed perpendicular to the mating axes when the primary and/or secondary connector pairs are mated together so that the connectors are mated only along the mating axis and not in off-axis direction. This feature lessons the chance that the wiring assemblies and/or the connector bodies may be irreparably damaged. T-boss protuberances disposed on the first boss and the second boss advantageously assist to prevent a scooping condition, or off-axis mating of the connectors in the primary and/or secondary connector pairs. Thumb bumps defined in the first and/or the second external planar walls of the respective plug connector, socket connector, or socket shunt connector advantageously provide a gripping surface for a roof installer to facilitate mating and unmating of these connectors during installation or servicing of the electrical connection system. Hollow core cavities defined within the plug, the socket, or the shunt socket connector may provide for ease of molding manufacturability of these respective connector bodies while further reducing material costs to produce these connector bodies.

While this invention has been described in terms of the preferred embodiment thereof, it is not intended to be so limited, but rather only to the extent set forth in the claims that follow.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. An electrical connection system comprising:
a mating axis;
at least one socket connector body configured to receive at least a portion of a plug connector body along the mating axis, the plug connector body including a generally axial planar first wall and a generally axial planar second wall opposingly spaced from said planar first wall by about a diameter thickness of at least one wire cable, the at least one wire cable being electrically connected to at least one electrical contact forming at least one wire assembly disposed intermediate the first and the second wall, and the first wall has a planar exterior surface and the second wall has a planar exterior surface, a first plane being defined along the planar exterior surface of the first wall and a second plane being defined along the planar exterior surface of the second wall such that said first plane has a parallel, spaced relationship with said second plane, the plug connector body further including,
at least one latch mechanism configured to secure the plug connector body to the at least one socket connector body so that the plug and the socket connector body are fully mated together, and the plug connector body is unmatable from the socket connector body when the latch mechanism is sufficiently engaged thereat by a tool,
wherein when the plug connector body is fully mated to the socket connector body the electrical connection system is generally disposed intermediate the first and the second plane.

2. The electrical connection system of claim 1, wherein the diameter thickness is in relation to a current-carrying capacity of the at least one wire assembly.

3. The electrical connection system of claim 2, wherein said electrical connection system is associated with a solar shingle electrical application.

4. The electrical connection system of claim 3, wherein said electrical current-carrying capacity in said solar shingle electrical application has an electrical current range from zero (0) amps DC to thirteen (13) amps DC.

5. The electrical connection system of claim 1, wherein when the plug connector body is fully mated to the socket connector body the electrical connection system is environmentally sealed from at least liquid fluid intrusion.

6. The electrical connection system of claim 5, further including,
a sealing ring disposed surrounding a plurality of bosses of the plug connector body and intermediate ends of the respective plug and the socket connector body when the plug and the socket connector body are mated, such that when the plug and the socket connector body are fully mated, said sealing ring sealingly engages with said respective ends.

7. The electrical connection system of claim 1, wherein at least the first and the second wall define at least one hole therethrough, and the tool is configured to engage the latch mechanism perpendicular to the mating axis through said hole when the plug connector body is fully mated with the socket connector body so that when the latch mechanism is sufficiently engaged thereat by the tool, the plug connector body is unmatable from the socket connector body.

8. The electrical connection system of claim 7, wherein the latch mechanism, when engaged by the tool inserted past the first wall or the second wall and in to the at least one hole, is unlatchable.

9. The electrical connection system of claim 1, wherein the at least one wire assembly is disposed in the plug connector body so as to respectively adjacently communicate with at least a portion of an inner surface of the first wall and at least a portion of an inner surface of the second wall, the plug connector body further being sealingly engaged to an insulation outer covering of the at least one wire cable adjacent a respective lead of the at least one wire cable.

10. The electrical connection system of claim 1, wherein the plug and the socket connector body respectively include a plurality of wire assemblies, said plurality of wire assemblies being disposed in a single row perpendicular to the mating axis when the plug connector body is mated to the socket connector body.

11. The electrical connection system of claim 1, wherein at least one socket connector further includes a shunt socket connector body configured for electrical communication with a terminating plug connector body, the terminating plug connector body including one or more wire cables being in electrical communication with a primary connector pair disposed in the electrical connection system.

12. A solar shingle arrangement adapted for rooftop applications, comprising:
a first solar shingle including at least one wire conductor for transmission of electrical signals from said first shingle; and
at least one connector in electrical connection with said at least one wire conductor, the at least one connector being adapted to mate with a corresponding at least one mating connector along a mating axis connected to a second solar shingle by at least one wire conductor, the at least one wire conductors each having a diameter thickness that is about a same thickness of the at least one connector and the at least one mating connector, the at least one connector including,
a connector body including at least one extended arm, and
at least one male electrical contact disposed in the connector body, the electrical contact including a plurality of bifurcated forked contacts that are laterally spaced apart, said bifurcated forked contacts being configured to receive a plurality of electrical mating contacts disposed in said corresponding mating connector in electrical connection with the second solar shingle, the mating connector including,
a mating connector body,
the plurality of electrical mating contacts, each mating contact including a plurality of bifurcated male contacts laterally spaced apart,
at least one shoulder disposed in the mating connector body that allows a latch connection to the at least one extended arm of the least one connector when the connectors are fully mated together, and the at least one connector is unmatable from the at least one mating connector when a tool sufficiently engages the at least one extended arm and moves that at least one extended arm away from the at least one shoulder, and
a first and a second boss extend from the mating connector body where the first boss has a different size from the second boss thereby allowing a keyed connection of the at least one connector and the mating connector when the at least one connector and the mating connector are mated together, the bosses further respectively including an alignment protrusion that assists the at least one connector to mate and unmate with the mating connector only along the mating axis.

13. A low profile electrical connection system adapted for electrically interfacing solar roof shingles with an energy storage device, comprising:
a plurality of socket connectors, a portion of the plurality of socket connectors being attached to a first plurality of wire cables, and at least one of the plurality of socket connectors being a socket shunt connector;
a plurality of plug connectors attached to a second plurality of wire cables, the plurality of plug connectors being received by the plurality of socket connectors, and the plurality of the plurality of plug connectors are unmatable from the plurality of socket connectors by using a tool sufficiently respectfully engaged against in the plurality of plug connectors,
wherein each plug connector has a first planar exterior surface and a second planar exterior spaced apart by about a diameter thickness of at least one wire cable in the plurality of second wire cables, and a first plane is defined along each first exterior surface and a second plane is defined along each second exterior surface such that when the plurality of plug connectors are received in the plurality of socket connectors, the respective plurality of socket connectors are disposed generally intermediate the respective first and the second plane.

14. The low profile connect system according to claim 13, wherein a rooftop includes a plurality of roof shingles some of which are solar roof shingles, and said plurality of roof shingles have a planar parallel relationship with a surface of the rooftop, and the plurality of plug connectors and the plurality of socket connectors are configured to underlie at least some roof shingles in said plurality of roof shingles on the rooftop so that when said plurality of plug connectors and said plurality of socket connectors underlie at least some roof shingles in said plurality of roof shingles, said planar parallel relationship is generally maintained.

15. A method to construct at least one connector for an electrical connection system, comprising:
plasma etching at least a section of insulation outer covering that surrounds an inner core of at least one wire cable, a portion of the insulation outer covering proximate an end of the wire cable being removed to expose a portion of the inner core to form a lead of the wire cable, the section being disposed adjacent the lead;
attaching the lead to at least one electrical contact to form at least one wire assembly;
disposing the at least one wire assembly in a mold; and
injection molding a connector body to surroundingly engage the wire assembly including at least a portion of the insulation outer covering adjacent the lead to form the at least one connector.

16. The method according to claim 15, wherein the steps in the method are performed in the order recited.

17. The method according to claim 15, wherein the step of injection molding the connector body further includes,
forming at least one hollow cavity in the connector body.

18. The method according to claim 15, wherein the least one connector includes at least a plug connector and a socket connector that is matable with the plug connector and secured together with at least one latch mechanism, and the at least one latch mechanism allows unmating of the plug and the socket connector when a tool is sufficiently engaged against the at least one latch mechanism, and the at least one connector further includes a shunt socket connector configured to also mate with the plug connector.

19. The method according to claim 18, wherein the at least one latch mechanism includes at least two latch mechanisms and said tool includes at least two prongs, and when the at least two prongs sufficiently engage the at least two latch mechanisms the plug connector is unmatable from at least one of,
(i) the socket connector, and
(ii) the shunt socket connector.

20. The method according to claim 15, wherein the insulation outer covering is formed from cross-linked polyethylene XLPE material and the connector body is formed from a polyamide PA66 material.

21. An electrical connection system for use with solar shingles on a rooftop, comprising:
a plurality of plug connectors; and
a plurality of socket connectors, with at least one socket connector in the plurality of socket connectors being a shunt socket connector, the plurality of socket connectors receiving the plurality of plug connectors along respective mating axes,
wherein each plug connector includes,
a planar first wall,
a planar second wall opposing the planar first wall perpendicular to the mating axes,
a pair of electrical contacts in contact with a pair of wire conductors forming a pair of plug wiring assemblies, each electrical contact having a portion that receives the wire conductor and another portion that includes a laterally spaced bifurcated members, and each bifurcated member includes a forked element, each tine in the forked element being laterally spaced one-to-another perpendicular to the mating axis, the planar first wall being spaced apart from the second planar wall by about a diameter thickness of each wire conductor in the pair of wire conductors, an end of each wire conductor in the pair of wire conductors being in communication with the first wall are the second wall, the first wall having an exterior surface defining a first plane and the second wall having an exterior surface defining a second plane, the first plane being generally parallel with the second plane,
a first plug boss having a first width,
a second plug boss having a second width greater than said first width, each boss having an alignment protrusion disposed an external surface of the respective first boss and the second boss,
a pair of apertures respectively including a shoulder,
a first plurality of plug grooves defined on a first external surface and a second plurality of plug grooves defined on a second external surface, the first and second plurality of grooves being disposed intermediate the each aperture in the pair of apertures,
an overmolded plug connector body that surrounds the plug wire assemblies in a manner so that the plug connector is environmentally sealed from at least liquid fluid intrusion in to the plug connector body through the pair of wire conductors, and
a sealing ring that encircles the first and the second boss,
polarity symbols disposed on an exterior surface of the first wall and an exterior surface of the second wall,
wherein each socket connector includes,
a pair of socket electrical contacts attached with a pair of wire conductors that form a pair of socket wiring assemblies, each socket electrical contact having a portion that receives the wire conductor and another portion that is a laterally spaced bifurcated portion, and each bifurcated portion includes a single tine,
a pair of laterally spaced flexible arms having respective nibs that communicate with the shoulders of the plug connector when the respective plug and the socket connector are mated together,
an overmolded socket connector body that surrounds the socket wire assemblies in a manner such that the socket connector is environmentally sealed from at least liquid fluid intrusion in to the socket connector through the pair of wire conductors attached to the socket connector,
a first plurality of socket grooves defined on a first external surface and a second plurality of socket grooves defined on a second external surface, the first and second plurality of grooves being disposed intermediate the pair of laterally spaced flexible arms,
and each socket connector receives the first and the second plug boss of each plug connector,
polarity symbols disposed exterior surfaces of the socket connector,
wherein the shunt socket connector includes,
a pair of electrical contacts electrically connected together by a wire cable forming a shunt wire assembly,
a first plurality of shunt socket grooves defined on a first external surface and a second plurality of shunt socket grooves defined on a second external surface, the first and second plurality of shunt socket grooves being disposed intermediate the each flexible arm in the pair of laterally spaced flexible arms on the shunt socket connector,
an overmolded shunt socket connector body that surrounds the shunt socket wire assemblies in a manner such that the shunt socket connector is environmentally sealed from at least liquid fluid intrusion in through the wire cable that attaches to the pair of electrical contacts of the shunt socket connector,
polarity symbols disposed exterior surfaces of the socket connector,
wherein the single tines of the plug connector are received by the respective forked elements of the socket connector and the sealing ring engages the plug and the socket connector or the shunt socket connector when the respective plug and the socket connector or shunt socket connector are mated together,
wherein the plurality of socket connectors respectively are unmatable from the plurality of plug connectors when a tool is inserted in the pair of apertures and engages against the pair of flexible arms in a manner that moves the flexible arms away from abutment with the respective shoulders, and
wherein when the plug connector is mated to the socket connector or the shunt socket connector, the respective socket connector or the shunt socket connector is disposed intermediate the first and the second plane.
